(19) United States
(12) Patent Application Publication
(10) Pub. No.: US 2021/0274601 A1
(43) Pub. Date: Sep. 2, 2021

(54) PTC Heating Device

(71) Applicant: Eberspächer catem Hermsdorf GmbH & Co. KG, Hermsdorf (DE)

(72) Inventors: Andreas Kümpel, Wünschendorf/Elster (DE); Yves Knüpfer, Caaschwitz (DE)

(21) Appl. No.: 17/186,248

(22) Filed: Feb. 26, 2021

(30) Foreign Application Priority Data
Feb. 27, 2020 (DE) 10 2020 202 508.8

(51) Int. Cl. H05B 3/28; H05B 3/06

(52) U.S. Cl. CPC H05B 3/283; H05B 2203/02; H05B 3/06

(57) ABSTRACT

A PTC heating device includes a PTC element and a frame element which forms a recess circumferentially surrounding the PTC element and being covered on both sides by electrically insulating plates that interact with the frame element for sealing the PTC element in the recess. In order to create a PTC heating device which allows for a reliable electrical connection of the PTC element to a power source while reliably sealing the PTC element in the recess, the insulating plates each be provided with a metallization that is connected, in an electrically conductively manner, to the PTC element. The metallization is connected in an electrically conductively manner, to an associated contact surface provided on the outer surface of the electrically insulating plate for the electrical connection of a power source to the PTC heating device.

### BACKGROUND OF THE INVENTION

### 1. Field of the Invention

The present invention relates to a PTC heating device with a PTC element and a frame element that forms a recess circumferentially surrounding the PTC element and being covered on both sides by electrically insulating plates that interact with the frame element for sealing the PTC element in the recess.

### 2. Background of the Invention

Such a PTC heating device is known from EP 1 921 896 A1.

In the previously known PTC heating device as well as with the present invention, the frame element is typically formed from electrically insulating plastic material. The frame element is also referred to as a position frame. It fully surrounds the PTC element circumferentially. The PTC element is slightly thicker than the frame element so that the main side surfaces of the PTC element protrude beyond the frame element. The main side surfaces of the PTC element are those surfaces of the regularly cuboid-shaped PTC element via which the heat is extracted from the PTC element and which are larger at least by a factor of 5 than the other surfaces, i.e. the surface or surfaces extending in the circumferential direction. Electrical contact of the PTC element to the power current is effected at least in the present invention at these main side surfaces.

The PTC element is sealed in the recess of the frame element. The oppositely disposed electrical insulating plates are accordingly connected to the frame element in such a way that the recess is encapsulated from the environment.

In the above prior art, the PTC element is energized through contact plates which are laterally extended beyond the frame element and there form connection strips for the plugged contact of the PTC heating device. At this point, adequate sealing must be ensured in a special way in order to prevent moisture or a fluid to be heated from reaching the recess from the outside. This is not always easy when the contact strips are led out of the frame element.

In the case of PTC heating devices of the kind mentioned at the outset, it is beneficial to extract the heat symmetrically on both main side surfaces of the PTC heating element. The PTC heating device of the present invention, like the PTC heating device known from prior art, is intended to be employed in a motor vehicle. Scalable production processes are required there. It is to be possible to manufacture the PTC heating device with consistent reliable quality.

### SUMMARY

The present invention is based on the problem of specifying a PTC heating device of the kind mentioned at the outset which allows for reliable electrical connection of the PTC element while reliable sealing the PTC element in the recess.

To solve this problem, the present invention proposes a PTC heating device having a PTC element and a frame element which forms a recess. The recess circumferentially surrounds the PTC element and is covered on opposed sides thereof by electrically insulating plates that interact with the frame element for sealing the PTC element in the recess. The insulating plates are each provided with a metallization that is connected, in an electrically conductive manner, to the PTC element and that is connected in an electrically conductive manner to an associated contact surface provided on the outer surface of the electrically insulating plate for an electrical connection to the PTC heating device. The metallization may abut, in an electrically conductive manner, against the PTC element. The metallization may be connected, in an electrically conductive manner, to an associated contact surface provided on the outer surface of the electrically insulating plate for establishing an electrical contact to the PTC heating device.

With the present invention, the electrical connection of the PTC element to the power current is effected via contact surfaces which are provided on the outer surface of the electrically insulating plate. The electrically insulating plate accordingly bears the corresponding contact surfaces. These contact surfaces are applied as electrically conductive segments to the electrically insulating plate and are connected to the latter. The electrically insulating plate has sufficient inherent dimensional rigidity so that, for example, direct adhesive bonding of the insulating plate to the frame element leads to a substantially rigid frame element in which the PTC element is circumferentially surrounded by the frame element and is covered on the oppositely disposed main side surfaces by the insulating plates in a dimensionally rigid manner.

These insulating plates directly abut against the PTC element in an electrically conductive manner. For this purpose, the electrically insulating plates are provided with a metallization that is in direct electrical contact with the PTC element. The contact can be established with electrically conductive adhesive. The contact can also be establish using electrically non-conductive adhesive, for the purpose of which the metallization on the electrically insulating plate and/or a metallization already provided anyway on the PTC element for the introduction of current into the PTC element that is designed as a semiconductor component is provided with a certain roughness, so that peaks of the roughness penetrate the adhesive layer and establish electrical contact on the oppositely disposed side. Electrically non-conductive adhesive is beneficial, as it typically connects the electrically insulating plate to the frame element and accordingly becomes part of the electrically insulating housing. Alternatively, electrically insulating adhesive can be applied to the outer circumference of the recess and bonded to the electrically insulating plate, whereas electrically conductive adhesive can be provided within this circumferential insulating bonding and connect the PTC element in an electrically conductive manner to the metallization of the electrically insulating plate.

It goes without saying that this metallization typically does not extend up to the edge of the electrically insulating plate. The situation is different at that point where the contact surface is provided. This contact surface can be provided on a circumferential edge of the electrically insulating surface. However, the contact surface may be provided on one of the main surfaces of the electrically insulating plate. However, the contact surface alone may be a region that is electrically in contact with the PTC element. The typical housing formed by the frame element and the electrically insulating plates is electrically insulating.

The frame element can be made of plastic material or electrically insulating ceramic material. The frame element can form one or more recesses. Each individual recess can accommodate one or more PTC elements. According to the considerations outlined above regarding electrically insulating adhesive in the edge region of the insulating plates, it is understood that the metallization is not provided over the entire surface on mutually oppositely disposed inner surfaces of the electrically insulating plates. The metallization is instead typically confined to that surface region which is in direct contact with the PTC element or against which the PTC element abuts directly or indirectly in an electrically conductive manner

With regard to a simple, effective and large-area connection, it is proposed according to a development of the present invention that the contact surface be provided on an outer main side surface of the electrically insulating plate. For this purpose, the contact surface is typically provided near an edge of the electrically insulating plate. The contact surface can have a metallization applied to the outer side of the electrically insulating plate and forming an end-to-end contact surface on the outer main side surface of the corresponding electrically insulating plate. This contact surface may be connected in an electrically conductive manner to the metallization by way of at least one via. The via penetrates the electrically insulating plate. Electrically conductive material typically penetrates a bore which is cut out in the electrically insulating plate and connects the metallization provided on the inside to the contact surface provided on the outside.

As mentioned above, the electrically insulating plate may be a plate formed from ceramic material. This plate is typically flat and only a few millimeters thick.

A layer with good thermal conductivity and electrical conductivity may be provided between the PTC element and the metallization which is sealed between the electrically insulating plates. The aforementioned electrically conductive adhesive can form such an electrically conductive layer. The electrical layer can also alternatively or additionally be formed, for example, from a graphite or copper film or plate. Good thermal conductivity as well as good electrical conductivity are important. A material should be used for this that allows for roughness peaks to penetrate into the electrically conductive layer, in particular on the surface of the PTC element, so that a planar contact is established between the metallization of the electrically insulating layer and the PTC element. The electrically conductive layer is no printed circuit board within the meaning of prior art mentioned above. It only provides the electrical contact between the metallization on the PTC element and the surface of the PTC element at a right angle to the main side surface. The electrically conductive layer is typically only disposed where the PTC element is provided disposed opposite to the electrically insulating layer. The electrically conductive layer may be realized having approximately the size of the main side surface of the PTC element.

In a manner known per se, the PTC heating device can be configured to be adapted to be plug-contacted to a power current. For this purpose, contact plates are proposed which are each electrically connected to the associated contact surface and project on one side beyond the associated electrically insulating plate. The respective contact plates can be circumferentially surrounded by an electrically insulating collar which circumferentially surrounds the contact surfaces and is provided at their height. The collar is then typically only provided over a short length of the electrically insulating plates and on one side at their edge. The collar can be formed by injection-mold coating the contact plates and the electrically insulating layers after abutting it against the frame element while sealing the PTC element and connected to this entity. The collar can also be formed by two shell elements which engage around the electrically insulating plates circumferentially and can be, for example, adhesively bonded to them. The collar typically has contact plate receptacles in which the contact plates are held in such a way that the contact plates abut with a contacting mating surface against the contact surface on the outer surface of the electrically insulating plates.

### BRIEF DESCRIPTION OF THE DRAWINGS

Further details and advantages of the present invention shall become apparent from the following description of an embodiment in combination with the drawing, in which:

FIG. 1 shows a perspective exploded view of the essential parts of the PTC heating device;

FIG. 2 shows the embodiment according to FIG. 1 after the electrically insulating plates have been joined and

FIG. 3 shows a perspective side view of the completed embodiment together with the contact surfaces.

### DETAILED DESCRIPTION

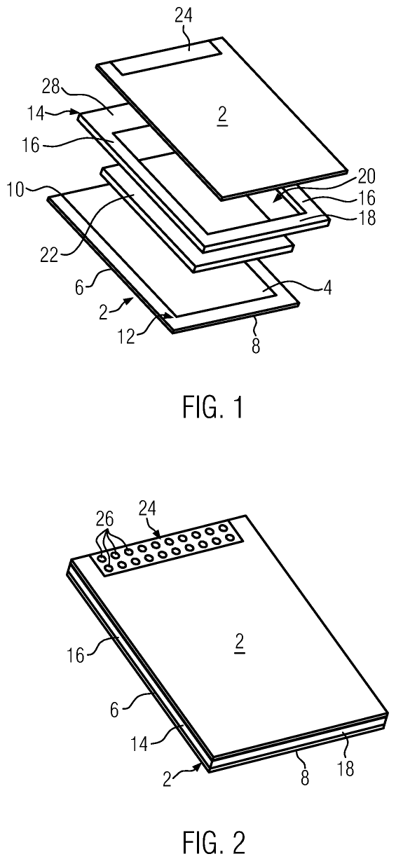

Provided with reference numeral 2 in FIG. 1 are two ceramic plates as examples of electrically insulating plates, which on oppositely disposed inner surfaces are provided with a metallization 4 that is spaced from the longitudinal edges, marked with reference numeral 6, of the ceramic plate 2 and a lower edge 8 and extends up to an upper edge 10. An electrically non-conductive U-shaped strip 12 is thereby provided on oppositely disposed inner surfaces of the respective ceramic plates 2. A frame element made of a ceramic material, denoted by reference numeral 14, has longitudinal tie members 16 and a lower transverse tie member 18, their width being matched to the width of the U-shaped strip 12. The frame element 14 is presently formed from aluminum oxide. The frame element 14 forms a recess 20 in which a PTC element 22 can be received with a small transverse spacing. In the exploded view according to FIG. 1, this PTC element 22 is still disposed below the frame element 14.

A contact surface 24, the upper one in FIG. 1, can be seen on the outside of the ceramic plate 2 and is in electrically conductive contact with the metallization 4 of the inner main side surface of the ceramic plate 2. As can be seen in FIG. 2 showing the finished heating cell composed of the two ceramic plates 2, the frame element 14, and the PTC element 22, this contact surface 24 is connected by way of vias 26 to the metallization 2 on the inner main side surface. By applying a metallization, an end-to-end rectangular contact surface 24 arises on the outer main side surface and is electrically connected to the metallization 4 by electrical conductor tracks 26 which extend in the thickness direction of the ceramic plate 2.

To assemble the heating cell shown in FIGS. 1 and 2, electrically non-conductive adhesive is typically applied onto the U-shaped strip 12. Electrically conductive adhesive is applied to the metallization 4 or the oppositely disposed main side surface of the PTC element 22. Alternatively or in addition, a further layer with good electrical conductivity can be arranged between the inner main side surface of the ceramic plate 2 and the PTC element 22. This electrically conductive layer can be a copper or graphite plate or film. It serves, in particular, to establish the planar electrical contact between the relatively rigid ceramic plate 2 and the main side surface of the PTC element 22. The main function of the electrically conductive layer is to absorb and equalize any possible punctiform contacts caused by roughness, in particular in the region of the PTC element 22, so that a planar contact between the metallization 4 and the PTC element 22 is given.

As conveyed in FIG. 1, an upper transverse tie member 28 is wider than the lower transverse tie member 18 and accordingly provides an abutment for the contact surface 24.

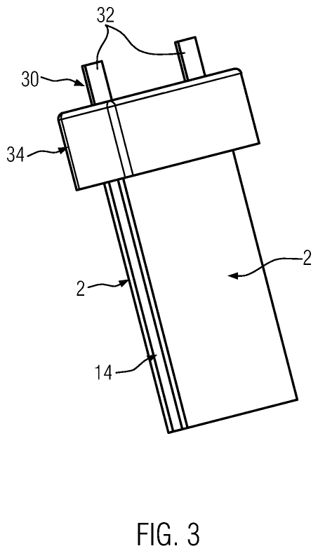

FIG. 3 shows the completed embodiment. It has two contact plates 30 which abut in a planar manner against the contact surface 24 and are accordingly provided with the width of the contact surface (cf. FIG. 2). Contact strips that are cut free are formed on opposite edges through the contact plate 30 and basically protrude beyond the PTC heating device as an extension of the longitudinal tie members 16. The upper region of the ceramic plates 2, corresponding approximately to the width of the upper transverse tie member 28, is surrounded by a collar 34 which surrounds the electrically insulating plates 2 and the frame element 14 circumferentially and there accommodates and closes the contact surfaces 24 as well as region of the contact plates 30 abutting thereagainst, so that a medium to be heated flowing against the outside of the ceramic plates 2 cannot reach the contact plates 30 or the contact surfaces 24, respectively. The collar 34 limits the exposed surfaces of the contact plates 30 provided for plugged contact to the contact strips 32. The collar 34 can be formed from resiliently soft material, so that it is suitable for sealing the PTC heating device in a partition wall which separates a heating chamber, in which the ceramic plates 2 are exposed for the dissipation of heat, from a connection chamber, in which the contact strips 32 are in plugged contact (cf. EP 3 334 242 A1). The collar can also be configured to be adapted for the attachment of resiliently soft seals or be formed integrally with an elastomeric seal.

The embodiment shown in FIG. 3 represents the finished PTC heating device. Medium to be heated flows directly against the outer surfaces of the ceramic plate 2 and is heated in particular by way of the outer main side surfaces of the ceramic plate. The collar 34 is disposed outside the region in which the PTC element 22 is connected to the ceramic plate 2 in an electrically conductive and thermally conductive manner Good heat extraction of the heat generated by the PTC element 22 is thus ensured. This results in a good degree of efficiency, especially since the PTC element 22 is connected to the ceramic plate 2 directly or via a layer conducting heat very well.

In the embodiment shown, the electrical contact is established between the contact surface 24 and the metallization 2 through the vias 26. In addition or as an alternative, a corner contact can be implemented by way of which the contact surface 24 is connected in an electrically conductive manner to the metallization 4 provided on the oppositely disposed main side surface. This corner contact extends over the face side upper edge 10 of the ceramic plate 4.

1. A PTC heating device comprising:
a PTC element; and
a frame element which forms a recess circumferentially surrounding the PTC element and being covered on opposed sides thereof by electrically insulating plates that interact with the frame element for sealing the PTC element in the recess, wherein
the insulating plates are each provided with a metallization that is connected, in an electrically conductive manner, to the PTC element and that is connected, in an electrically conductive manner, to an associated contact surface provided on the outer surface of the electrically insulating plate for an electrical connection to the PTC heating device.

2. The PTC heating device according to claim 1, wherein the contact surface is provided on an outer main side surface of the electrically insulating plate.

3. The PTC heating device according to claim 1, wherein the contact surface is connected in an electrically conductive manner to the metallization on an outer main side surface of the electrically insulating plate by way of at least one via.

4. The PTC heating device according to claim 1, wherein the electrically insulating plates are flat.

5. The PTC heating device according to claim 1, wherein the electrically insulating plates are formed of a ceramic material.

6. The PTC heating device according to claim 1, wherein a layer with good thermal conductivity and electrical conductivity is provided between the PTC elements, and wherein the metallization and is sealed between the electrically insulating plates.

7. The PTC heating device according to claim 1, further comprising contact plates which are each electrically connected to an associated contact surface and which project on one side beyond an associated electrically insulating plate.

8. The PTC heating device according to claim 6, further comprising contact plates which are each electrically connected to an associated contact surface and project on one side beyond an associated electrically insulating plate.

9. The PTC heating device according to claim 1, further comprising an electrically insulating collar which circumferentially surrounds the electrically insulating plates and the frame element at a height of the contact surfaces and to which the contact plates are connected.

10. The PTC heating device according to claim 1, wherein the PTC heating device is configured to be employed in a motor vehicle.
